(19) United States
(12) Patent Application Publication
(10) Pub. No.: US 2025/0205519 A1
(43) Pub. Date: Jun. 26, 2025

(54) ABSEILING DEVICE WITH TORQUE LIMITER

(71) Applicant: MITTELMANN SICHERHEITSTECHNIK GMBH & CO. KG, Velbert (DE)

(72) Inventors: Bircihan CEYLAN, Velbert (DE); Jürgen MEYER, Velbert (DE)

(21) Appl. No.: 18/848,576

(22) PCT Filed: Mar. 8, 2023
(86) PCT No.: PCT/DE2023/100179

§ 371 Date: Sep. 19, 2024

(30) Foreign Application Priority Data
Mar. 21, 2022 (DE) 20 2022 101 467.1

(51) Int. Cl. A62B 1/14; B66D 5/04

(52) U.S. Cl. CPC A62B 1/14; B66D 5/04

(57) ABSTRACT

An abseiling device, includes a guide arrangement that can be rotated in two directions for guidance of a traction means. A braking device is coupled to the guide arrangement, where a drive means is connectable to the guide arrangement for actuating the guide arrangement. A torque limiter with a first coupling body and a second coupling body. decouples the drive means and the guide arrangement when a threshold value of a torque is exceeded. The first coupling body is displaced in translation relative to the second coupling body between a coupling position and a decoupling position.

### CROSS REFERENCE TO RELATED APPLICATIONS

This application is a U.S. National Phase application under 35 U.S.C. § 371 of International Application No. PCT/DE2023/100179, filed on Mar. 8, 2023, and claims benefit to German Patent Application No. DE 20 2022 101 467.1, filed on Mar. 21, 2022. The International Application was published in German on Sep. 28, 2023 as WO 2023/179813 A1 under PCT Article 21(2).

### FIELD

The invention relates to an abseiling device comprising a guide arrangement rotatable in both directions for guiding a traction means, a braking device coupled to the guide arrangement, wherein a drive means can be connected to the guide arrangement for actuating the guide arrangement, and a torque limiter with a first coupling body and a second coupling body, wherein the torque limiter decouples the drive means and the guide arrangement when a threshold value of the torque is exceeded.

### BACKGROUND

In practice, abseiling devices are used as rescue lifting devices, for example to rescue people who have fallen down. These not only require a means of lowering a person at a limited speed on a traction means such as a rope, but also require that-for example to unlock a locking arrangement or to rescue a person from a crevasse-a drive means is provided for the traction means guided on a guide arrangement, such as a guide pulley, for example a handwheel with which the load can be lifted in the opposite direction to the lowering direction. However, the problem here is that the torque introduced by the handwheel into the gear or into a locking arrangement of the abseiling device can already lead to damage to the parts mentioned. To prevent such damage, it is known to use a torque limiter in an abseiling device that enables decoupling if the torque introduced is too high.

DE 20 2015 001 685 U1 describes a abseiling device comprising a housing, a guide arrangement arranged in the housing and rotatable in both directions and a braking device coupled to the guide arrangement and designed as a centrifugal brake. Furthermore, the abseiling device comprises a torque limiter for decoupling a motorized drive means that can be coupled to the abseiling device for the purpose of actuating the guide arrangement. In a first embodiment, the torque limiter is formed by a plug-in part and a sleeve part, which are inserted in the region of a handwheel, wherein a torque limiter is effected by the plug-in part slipping relative to the sleeve part when a torque acting on the plug-in part by a motorized drive means exceeds a predetermined threshold value.

DE 10 2006 050 995 B4 shows a torque limiter for decoupling a drive shaft rotatable about a drive axle from an output shaft, wherein the torque limiter comprises a first clutch body and a second clutch body, which are coupled to one another via a plurality of detent elements. If a predetermined torque threshold value is exceeded, the first clutch body is axially displaced relative to the second clutch body so that the detent elements become disengaged and the first clutch body slips relative to the second clutch body.

### SUMMARY

In an embodiment, the present disclosure provides an abseiling device. The abseiling device includes a guide arrangement that can be rotated in two directions for guidance of a traction means. A braking device is coupled to the guide arrangement, wherein a drive means is connectable to the guide arrangement for actuating the guide arrangement, and a torque limiter with a first coupling body and a second coupling body decouples the drive means and the guide arrangement when a threshold value of a torque is exceeded. The first coupling body is displaced in translation relative to the second coupling body between a coupling position and a decoupling position.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an end view of a first embodiment of a abseiling device, according to an embodiment of the present disclosure;

FIG. 2 shows a section alongline A-A through the abseiling device from FIG. 1, according to an embodiment of the present disclosure; and

FIG. 3 shows a detailed view in the area of the torque limiter, according to an embodiment of the present disclosure.

### DETAILED DESCRIPTION

The present invention describes an abseiling device that reliably prevents damage to the person to be rescued or to parts of the abseiling device when rescuing persons in particular.

According to one aspect of the invention, an abseiling device is provided, comprising a guide arrangement rotatable in both directions for guiding a traction means, a braking device coupled to the guide arrangement, wherein a drive means is connectable to the guide arrangement for actuating the guide arrangement. Furthermore, the abseiling device comprises a torque limiter with a first coupling body and a second coupling body, wherein the torque limiter decouples the drive means and the guide arrangement when a threshold value of the torque is exceeded. The abseiling device according to the invention is characterized in that the first coupling body can be displaced in translation relative to the second coupling body between a coupling position and a decoupling position. Advantageously, a decoupling of the drive by means of and the guide arrangement can be designed in such a way that the mechanical vibrations or acoustically perceptible noises caused to a user of the abseiling device according to the invention by the translatory displacement of the first coupling body are clearly conveyed that the threshold value of the torque has been exceeded and a reduction of the torque may be performed accordingly. This further advantageously reduces the stress on the torque limiter and thus extends the service life or the maintenance interval of the torque limiter. The abseiling device according to the invention advantageously enables external drive means to be connected directly or indirectly to the guide arrangement, the torque of which often exceeds the torque for rescuing a person and which are generally not permitted to actuate the guide arrangement due to the associated risk of injury. This allows the abseiling device to be coupled to an external drive means without the risk of injury to the person or load to be lifted, and thus also allows other than manual force to be transmitted to the traction means. The abseiling device thus becomes a versatile and reliable rescue lifting device.

In some embodiments, the torque limiter comprises a pretensioning device with at least one pretensioning means, which pretensions the first coupling body in the direction of the second coupling body into the coupling position. In some embodiments, the pretensioning device is adjustable so that the threshold value of the torque above which the first coupling body and the second coupling body are decoupled by translational displacement can be precisely defined. In an advantageous further development, the pretensioning means is designed as a spring element, in particular as a diaphragm spring. This makes the pretensioning means particularly cost-effective and compact.

In some embodiments, it is provided that first detent elements are arranged on the first coupling body and second detent elements are arranged on the second coupling body, which engage with each other in a form-fit and frictionally engaged manner in a coupling position. The first detent elements and the second detent elements are designed as detent balls. The first detent elements and the second detent elements are frictionally engaged with one another in the decoupling position of the first coupling body and the second coupling body. Advantageously, when the threshold value of the torque is exceeded, the translational displacement of the first coupling body from a coupling position into the decoupling position is effected automatically, since the spherical shape of the detent elements ensures that a force component acts in the direction of the translational displacement when a torque is present between the coupling bodies.

In an expedient further development, the first coupling body has first recesses for receiving the first detent elements and the second coupling body has second recesses for receiving the second detent elements. Advantageously, the detent elements are fixed relative to the respective coupling body and cannot be displaced in translation relative to their respective coupling body. Conveniently, the first detent elements protrude from the first recesses and the second detent elements protrude from the second recesses so that the first detent elements engage with the second detent elements. Advantageously, the coupling between the first coupling body and the second coupling body takes place exclusively via their detent elements.

In some embodiments, the first detent elements are arranged concentrically on an end face of the first coupling body facing the second coupling body and the second detent elements are arranged concentrically on an end face of the second coupling body facing the first coupling body. In an advantageous further development, the neighboring first detent elements and the neighboring second detent elements are each arranged equidistant from one another. In some embodiments, the distance between adjacent first detent elements is equal to the distance between adjacent second detent elements.

In some embodiments, the first coupling body is axially displaceable relative to the second coupling body along a common axis of rotation. Advantageously, decoupling is particularly reliable, especially when the detent elements are designed as detent balls, and also takes place with a correspondingly perceptible mechanical vibration and with the generation of audible noises.

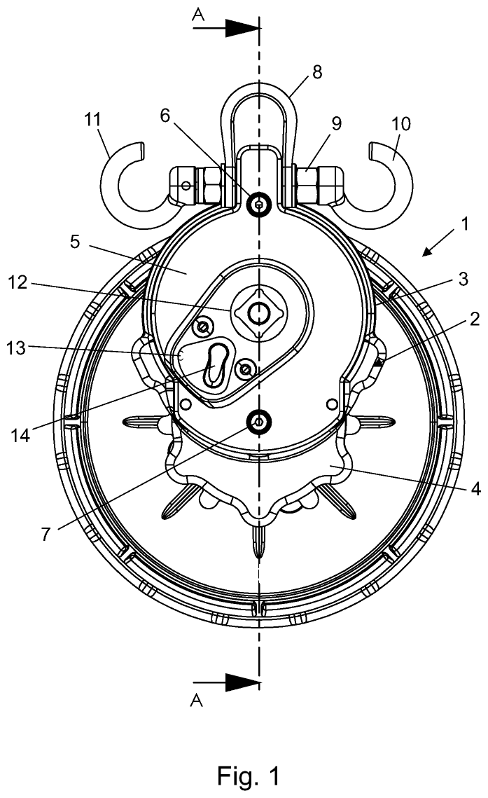

FIG. 1 shows an embodiment of an abseiling device 1 in a frontal view. The abseiling device 1 comprises a housing 2, wherein the housing 2 comprises a first housing part 3 and a second housing part 4, which are connected to each other. The first housing part 3 is closed on a side facing away from the second housing part 4 with a first housing cover 5, wherein the first housing cover 5 is fastened to the first housing part 3 with two screws 6, 7.

A snap hook 8 is attached to an upper side of the first housing part 3 via a pin 9, so that the abseiling device 1 can be advantageously suspended from a fixed point. Two hooks 10, 11 are firmly arranged at the opposite ends of the pin 9, over which a pulling means in the form of a rope can be passed.

The abseiling device 1 further comprises a locking device 12 designed as a ratchet, which makes it possible to lock the rotation of a guide arrangement provided in the abseiling device 1 for guiding a traction means in at least one direction of rotation. The locking device 12 comprises a switching arrangement 13 which can switch over the locking by means of an externally accessible switching element 14.

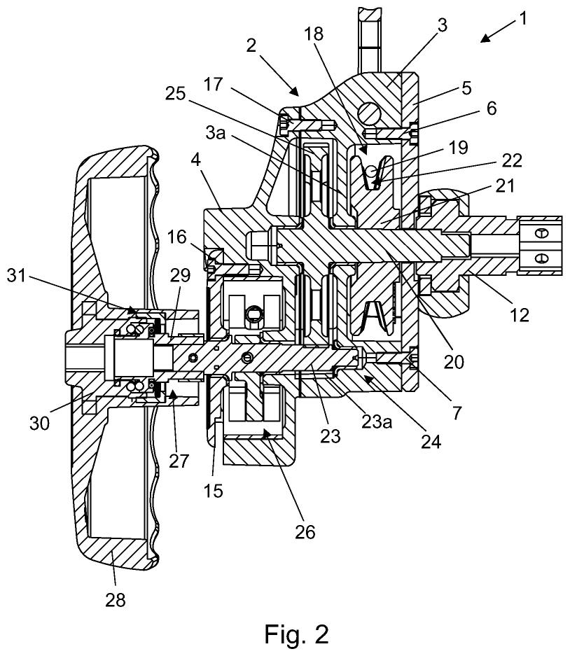

FIG. 2 shows a cross-sectional view of a section along the dashed line A-A from FIG. 1. In this view it can be seen that the housing 2 of the abseiling device 1 is formed by the first housing part 3 and the second housing part 4, the first housing part 3 and the second housing part 4 being screwed together by means of several screws, of which one screw 17 is shown here. The first housing part 3 is closed by the first housing cover 5, which is detachably fastened to the first housing part 3 by means of the screws 6, 7, and the second housing part 4 is closed by a second housing cover 15, which is fastened to the second housing part 4 by means of several screws, of which one screw 16 is shown here.

As can be seen in the cross-sectional view, the abseiling device 1 comprises a guide arrangement 18, which can be rotated in both directions, for guiding a traction means 19 in the form of a cable, wherein the guide arrangement 18 comprises a first shaft 20. The guide arrangement 18 is largely arranged in the first housing part 3. A cable sheave 21 is non-rotatably connected to the first shaft 20, wherein the cable sheave 21 has a radially circumferential V-shaped profile 22, in which the traction means 19 is guided. The first shaft 20 projects into the locking device 12, which is designed as a ratchet, and is coupled to it in a rotationally fixed manner, so that the rotation of the first shaft 20 or of the cable sheave 21 coupled in a rotationally fixed manner to the first shaft 20 can be locked in at least one direction of rotation.

Furthermore, the abseiling device 1 comprises a second shaft 23, which is coupled to the first shaft 20 via a gear 24. The second shaft 23 projects axially beyond the second housing cover 15 and is rotatably mounted circumferentially in the second housing cover 15 and in the first housing part 3. The second shaft 23 has a circumferentially toothed section 23a, which meshes with a gearwheel 25 formed integrally with the first shaft 20 to form the gear 24 or is in gear engagement.

The ratio of the circumferences of the circumferentially toothed section 23a and the gearwheel 25 is approximately 1 to 9, so that the transmission 24 is designed as a reduction gear. The first shaft 20 with the gearwheel 25 is rotatably mounted with a first end in the first housing part 3 and with a second end in the second housing part 4. In addition, the first shaft 20 is supported centrally in an opening of a partition wall 3a of the first housing part 3, which at the same time spatially separates the cable sheave 21 from the gearwheel 25. As a result, the cable pulley 21 is arranged in a separate sub-chamber within the housing 2, this sub-chamber being open at the bottom so that the two ends of the traction means 19, which is in the form of a cable, are guided downwards out of the housing 2.

A brake arrangement 26 designed as a centrifugal brake is connected to the second shaft 23, which causes a braking force when a certain rotational speed of the second shaft 23 is exceeded and slows down the rotational movement of the gearbox 24 and thus the rotational speed of the first shaft 20 or the pulley 21 as a whole.

Furthermore, the abseiling device 1 comprises a mechanical torque limiter 27, which serves to limit a torque acting externally on the second shaft 23 or on the transmission 24 and the first shaft 20. The abseiling device 1 according to the invention can thus be used flexibly as a rescue lifting device, whereby a force on the traction means 19 is limited and thus, in addition to preventing damage to the transmission 24 or the first shaft 20 or the second shaft 23, a risk of serious injury to the person to be lifted by means of the traction means 19 is also prevented. In particular, the torque limiter 27 prevents the pulling means 19, which is designed as a cable with a load attached to it, in particular the load of a person to be rescued, from being subjected to a high torque, which can lead to serious injuries in the event of jamming or the like.

In the embodiment example shown here, the torque limiter 27 is arranged between the second shaft 23 and a handwheel 28. The torque limiter 27 comprises a first clutch body 29 and a second clutch body 30, wherein the first clutch body 29 is preloaded in the direction of the second clutch body 30 via a preloading device 31.

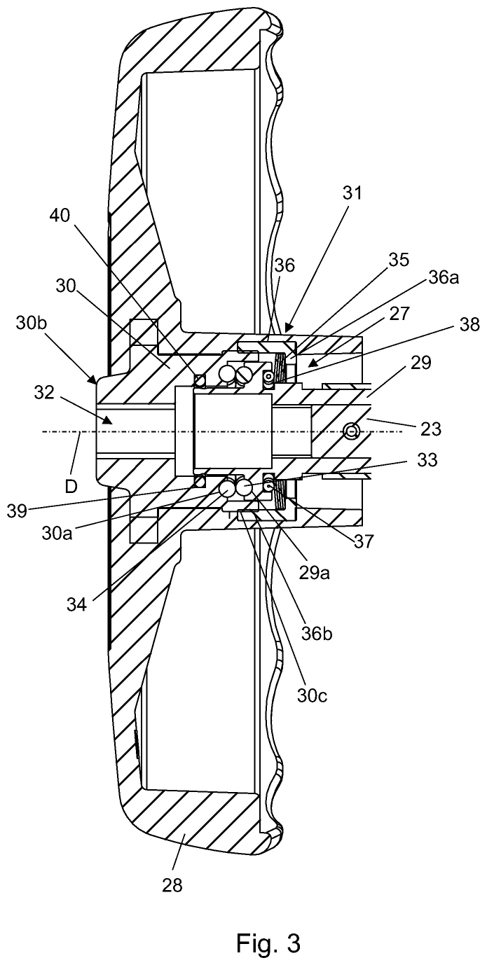

FIG. 3 shows a detailed view in the area of the torque limiter 27. The first coupling body 29 is coupled non-rotatably to the second shaft 23, so that when the first coupling body 29 is rotated about an axis of rotation D shown here as a dotted line, the second shaft 23 is also rotated about the same axis of rotation D. The second coupling body 30 is arranged concentrically to the axis of rotation D and has, on an end face facing away from the first coupling body 29, a connecting section 30b which partially protrudes from the handwheel 28 and is provided for connecting the second coupling body 30 to an external drive means, for example a cordless screwdriver or other motorized drive means. The connecting section 30b has a central recess 32 for a rotationally positive connection with such a drive means.

In the present embodiment example, the central recess 32 has a polygonal profile which is designed to fit a drive shaft of a drive means. Advantageously, the second coupling body 30 can thus be set into a driven rotation by means of the drive means and thus, insofar as a predetermined threshold value of a torque is not exceeded, a rotation of the sheave 21 can be driven due to the existing coupling with the second shaft 23. However, if the predetermined threshold value of the torque is exceeded, the drive means is decoupled from the second shaft 23 or the cable sheave 21.

The first coupling body 29 has a plurality of first recesses 29a on an end face facing the second coupling body 30 and the second coupling body 30 has a plurality of second recesses 30a on an end face facing the first coupling body 29. The first recesses 29a accommodate first detent elements 33 designed as detent balls and the second recesses 30a accommodate second detent elements 34 designed as detent balls, wherein the first detent elements 33 and the second detent elements 34 project axially from their respective recesses 29a, 30a, so that the first detent elements 33 and the second detent elements 34 contact each other under the pretension of the pretensioning device 31.

The pretensioning device 31 comprises a pretensioning means 35 designed as a disk spring, whereby the pretensioning means 35 is arranged or clamped between an adjusting element 36 designed as an adjusting nut and the first clutch body 29. The adjusting element 36 has a radially inwardly directed abutment 36a, on which the pretensioning means 35 is axially supported. The adjusting element 36 also has an internal thread 36b, which meshes with an external thread 30c provided on the second coupling body 30. Advantageously, the preload force of the first coupling body 29 in the direction of the second coupling body 30 and thus also the threshold value of the torque at which the decoupling between the first coupling body 29 and the second coupling body 30 takes place can thus be determined. For this purpose, the adjusting element 36 is screwed onto the second coupling body 30 and, when the desired preload force, which determines the threshold value of the torque, is reached, is secured axially twice relative to the second coupling body 30 via a pinning.

The pretensioning means 35 is supported axially on the other side on a first ball bearing 37, which is arranged on the first clutch body 29 on an end face facing away from the first detent elements 33, so that the first clutch body 29 can rotate relative to the pretensioning means 35. The first ball bearing 37 is arranged in a groove 38 of U-shaped cross-section running concentrically around the axis of rotation D in such a way that the bearing balls present in the first ball bearing 37 project axially above an upper leg of the U, so that the pretensioning means 35 is supported on the bearing balls.

Furthermore, a second ball bearing 40 is arranged in a further circumferential U-shaped groove 39 of the second clutch body 30, with the bearing balls projecting downwards from the U-shaped groove 39 in the direction of the first clutch body 29, so that the first clutch body 29 can rotate relative to the second clutch body 30 when the first detent elements 33 and the second detent elements 34 become disengaged when a threshold value of the torque is exceeded, thus causing a decoupling between the first clutch body 29 and the second clutch body 30. The second clutch body 30 is injected into the handwheel 28 to prevent it from rotating. In FIG. 2 or in Fig. the first clutch body 29 is in a decoupling position relative to the first clutch body.

When a predetermined threshold value of a torque is exceeded, the first detent elements 33 slip relative to the second detent elements 34, whereby at the same time an axial displacement of the first coupling body 29 relative to the second coupling body 30 takes place against the pretension of the pretensioning device 31 or the pretensioning means 35 into a decoupling position. Insofar as the threshold value of the torque is exceeded, a continuous engaging and disengaging movement of the first detent elements 33 and second detent elements 34 takes place, whereby this can be clearly perceived from the outside both mechanically and acoustically by a user of the abseiling device 1, so that the user is automatically signaled during a rescue lifting operation that the drive means connected to the abseiling device 1 via the central recess 32 has too high a torque and a corresponding reduction of the load on the drive means may be required, since no higher torque is possible for the rescue lifting operation anyway. This advantageously prevents a user from applying excessive torque to the abseiling device 1 over a longer period of time.

The invention has been explained above with reference to an embodiment example in which an adjusting element with a screw thread is shown. It is understood that the one adjusting element can also be used, for example, as a detent element with discrete detent positions. In addition, it is also possible to use adjusting elements which can be connected to the second clutch body 30 by a material connection, so that the threshold value of the torque is set permanently by the manufacturer and cannot be set easily by the user. However, in some embodiments, the adjustment element is designed in such a way that axial adjustment and detachable fixing at certain positions takes place, so that readjustment is possible.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An abseiling device, comprising:
a guide arrangement that is configured to be rotated in two directions for guidance of a traction means,
a braking device coupled to the guide arrangement,
wherein a drive means is connectable to the guide arrangement for actuating the guide arrangement, and
a torque limiter with a first coupling body and a second coupling body, wherein the torque limiter decouples the drive means and the guide arrangement when a threshold value of a torque is exceeded,
wherein
the first coupling body is configured to be displaced in translation relative to the second coupling body between a coupling position and a decoupling position.

2. The abseiling device according to claim 1, wherein the torque limiter comprises a pretensioning device with at least one pretensioning means, which pretensions the first coupling body in a direction of the second coupling body into the coupling position.

3. The abseiling device according to claim 2, wherein the pretensioning device is adjustable, so that the threshold value of the torque above which decoupling of the first coupling body and the second coupling body takes place by translational displacement is determined.

4. The abseiling device according to claim 2, wherein the at least one pretensioning means is designed as a spring element.

5. The abseiling device according to claim 2, wherein the at least one pretensioning means is arranged or clamped between an adjusting element designed as an adjusting nut and the first coupling body.

6. The abseiling device according to claim 5, wherein the adjusting element has a radially inwardly directed abutment against which the at least one pretensioning means is axially supported.

7. The abseiling device according to claim 6, wherein the adjusting element has an internal thread which meshes with an external thread provided on the second coupling body.

8. The abseiling device according to claim 7, wherein the at least one pretensioning means is supported axially on a first ball bearing, which is arranged on the first coupling body on an end face facing away from a first detent elements, so that the first coupling body is configured to rotate relative to the at least one pretensioning means.

9. The abseiling device according to claim 8, wherein the first ball bearing is arranged in a groove of U-shaped cross-section running concentrically around an axis of rotation in such a way that bearing balls present in the first ball bearing project axially above an upper U-leg, such that the at least one pretensioning means is supported on the bearing balls.

10. The abseiling device according to claim 1, wherein first detent elements are arranged on the first coupling body and second detent elements are arranged on the second coupling body, and wherein in a coupling position, the first detent elements and the second detent elements engage with one another in a form-fitting and frictionally engaged manner.

11. The abseiling device according to claim 10, wherein the first detent elements and the second detent elements are designed as detent balls.

12. The abseiling device according to claim 10, wherein the first detent elements and the second detent elements are frictionally engaged with one another in the decoupling position of the first coupling body and the second coupling body.

13. The abseiling device according to claim 11, wherein the first coupling body has first recesses for receiving the first detent elements and the second coupling body has second recesses for receiving the second detent elements.

14. The abseiling device according to claim 13, wherein the first detent elements protrude from the first recesses and the second detent elements protrude from the second recesses, such that the first detent elements engage with the second detent elements.

15. The abseiling device according to claim 10, wherein the first detent elements are arranged concentrically on a first end face of the first coupling body facing the second coupling body and the second detent elements are arranged concentrically about an axis of rotation on a second end face of the second coupling body facing the first coupling body.

16. The abseiling device according to claim 15, wherein each of the first detent elements and the second detent elements are each arranged equidistant from one another.

17. The abseiling device according to claim 16, wherein a first distance between each of the first detent elements is equal to a second distance between each of the second detent elements.

18. The abseiling device according to claim 1, wherein the first coupling body is axially displaceable relative to the second coupling body.

19. The abseiling device according to claim 18, wherein the first coupling body and the second coupling body are mounted so as to be rotatable coaxially about an axis of rotation.

20. The abseiling device according to claim 19, wherein the first coupling body is axially displaceable relative to the second coupling body in a direction of the axis of rotation.
